(19) United States
(12) Patent Application Publication
(10) Pub. No.: US 2026/0350648 A1
(43) Pub. Date: Nov. 5, 2026

(54) FACILITATING MUNICIPAL ENGAGEMENT AND LOCAL ECONOMIC GROWTH THROUGH A DIGITAL LOYALTY PLATFORM

(71) Applicant: CityPerks LLC, Grand Prairie, TX (US)

(72) Inventor: Trinity Ojo, Grand Prairie, TX (US)

(21) Appl. No.: 19/657,280

(22) Filed: Apr. 24, 2026

Related U.S. Application Data
(60) Provisional application No. 63/844,214, filed on Jul. 15, 2025.
(60) Provisional application No. 63/798,411, filed on May 1, 2025.

(51) Int. Cl. G06Q 30/0208; G06Q 30/0202; G06Q 30/0207; G06Q 30/0226

(52) U.S. Cl. CPC G06Q 30/0208; G06Q 30/0202; G06Q 30/0224; G06Q 30/0231

(57) ABSTRACT

Techniques for facilitating municipal engagement and local economic growth through a digital loyalty platform are described. In some implementations, a server may receive community engagement data from one or more community user devices, commercial devices, and public service devices, wherein the community engagement data may include a plurality of public activity records. The server may apply the community engagement data to a point allocation engine to determine point values associated with the public activity records and may generate public activity metrics based on the records and their associated point values. The system may populate an electronic dashboard with the public activity records and metrics, wherein the dashboard may be accessible to community user devices, commercial devices, and public service devices across a network.

### BACKGROUND

Loyalty systems may be employed by businesses to encourage customer retention and engagement through rewards programs. These systems may operate independently, focusing on individual business objectives and customer interactions. Municipalities may utilize various tools to promote civic participation, such as organizing community events or offering incentives for local involvement.

### BRIEF DESCRIPTION OF THE DRAWINGS

For a detailed description of various examples, reference will now be made to the accompanying drawings in which:

FIG. 1 illustrates an example of a system for information processing configured for facilitating municipal engagement and local economic growth through a digital loyalty platform in accordance with aspects of the present disclosure.

FIG. 2 illustrates a diagram of techniques for facilitating municipal engagement and local economic growth through a digital loyalty platform in accordance with various aspects of the present disclosure.

FIG. 3 illustrates a points allocation flowchart that supports techniques for facilitating municipal engagement and local economic growth through a digital loyalty platform in accordance with various aspects of the present disclosure.

FIG. 4 illustrates a points allocation flowchart that supports techniques for facilitating reward redemption via resident dashboard, in accordance with one or more embodiments.

FIG. 5 depicts an example redemption-side workflow in accordance with one or more embodiments.

FIG. 6 shows an example resident dashboard landing page.

FIG. 7 shows a municipality dashboard which supports techniques for facilitating municipal engagement and local economic growth through a digital loyalty platform in accordance with various aspects of the present disclosure.

FIG. 8 shows a merchant dashboard which supports techniques for facilitating municipal engagement and local economic growth through a digital loyalty platform in accordance with various aspects of the present disclosure.

FIG. 9 shows an example of a hardware system for implementation of the various computer systems in accordance with the disclosed embodiments.

### DETAILED DESCRIPTION

The following description relates to data-driven digital solutions for loyalty programs and analytics. More specifically, the various embodiments are directed to software-based methods and systems that coordinate real-time interactions between residents, local businesses, and city administrators, all within a secure, centralized infrastructure.

According to one or more embodiments, the architecture employs a set of modules that process engagement data from multiple sources. A point allocation engine collects public activity records from community devices, merchant portals, and public service interfaces. These activity records may include local purchases, event attendance, or public service participation. The engine assigns weighted or tiered point values according to predefined rules, which can account for factors like geographic location, frequency of participation, and activity type. The resulting data is transformed into user-facing metrics, including activity summaries and point balances.

In some embodiments, techniques described herein are directed to the generation of dashboards that visualize both real-time and historical engagement patterns. Administrators and merchants have access to detailed redemption data, trend analytics, and demographic breakdowns. City officials can launch targeted campaigns, trigger notifications tied to specific engagement thresholds, and update reward offerings based on observed traffic or purchasing behavior. Residents benefit from an at-a-glance view of their point totals, along with personalized promotions and geographically relevant updates.

By consolidating these functions into a unified platform that captures, processes, and displays data in real time, the technology addresses a technical problem of fragmented communication and siloed data. Conventional approaches require municipalities, merchants, and residents to maintain separate, disconnected systems for tracking engagement, managing rewards, and communicating updates. This fragmentation results in data inconsistencies, delayed feedback, and redundant infrastructure costs. The claimed software-based platform provides a technical solution by integrating multiple data streams through a centralized point allocation engine, applying consistent analytics rules via a metric generation engine, and delivering immediate feedback to stakeholders through coordinated dashboard modules. In doing so, the platform transforms otherwise disparate events detected or performed by a user engaging with different services into a common metric system in the form of a consolidated rewards program. This arrangement not only reduces the overhead of maintaining separate systems for city officials, merchants, and residents but also ensures that each participant can interact with accurate, up-to-date information through a single unified interface. Accordingly, the system leverages the common analysis to improve data accuracy and completeness across various system.

In some examples, municipalities may face challenges in fostering local economic growth and civic engagement due to the absence of a unified platform that connects residents, businesses, and city initiatives. Local businesses may struggle to compete with national chains that dominate digital marketing and loyalty programs, leaving them with limited tools to drive customer retention and engagement. Residents may often miss opportunities to participate in local events or take advantage of business promotions due to fragmented communication channels. Additionally, cities may lack access to real-time data and analytics to measure the effectiveness of their programs and campaigns, making it difficult to optimize strategies and allocate resources effectively. These disconnected systems and processes may create inefficiencies and missed opportunities for economic and community development.

According to some implementations, a digital platform may provide a centralized loyalty system that integrates municipalities, businesses, and residents. Residents may earn digital points for engaging in city-sponsored events or making purchases at registered local businesses. These points may be tracked and aggregated within the platform, allowing users to redeem them for rewards such as discounts, goods, or services. The system may connect civic and commercial incentives, creating a seamless experience for all stakeholders.

The platform may include a rule-based point allocation engine that automates the distribution of points based on predefined criteria. Points may be awarded for two primary activities: business engagement, where users may earn points for making qualifying purchases or interacting with business promotions, and city participation, where users may earn points for attending or participating in city-sponsored events, such as community programs or town halls. The engine may record user actions and allocate points in real time, ensuring accurate tracking and rewarding of behavior.

Distinct dashboards may be available for residents, businesses, and city administrators, each tailored to their specific needs. The resident dashboard may allow users to register, view nearby offers, track earned points, and redeem rewards. The business dashboard may enable merchants to enroll in the program, create promotions, track customer engagement, and analyze performance metrics. The city administrator dashboard may provide tools for launching campaigns, managing incentives, and reviewing resident behavior through analytics.

The platform may collect data in real time from user interactions, including purchases, event attendance, and other point-earning activities. This data may be routed through the rule-based engine and stored securely within the platform’s infrastructure, enabling immediate feedback and insights for all stakeholders.

Advanced analytics capabilities may provide actionable insights to cities and businesses. City administrators may access data on resident engagement trends, economic activity, and program participation. Businesses may analyze customer behavior, offer engagement, and redemption rates to optimize their marketing strategies. The analytics dashboard may surface trends associated with point-earning behaviors, such as visits to libraries, recreation centers, and other community facilities.

City administrators may use the platform to design and launch civic campaigns aimed at increasing resident engagement. Campaigns may include incentives for attending city events, participating in community programs, or supporting local businesses. Businesses may create targeted promotions and loyalty campaigns to drive foot traffic and repeat visits.

Residents may redeem accumulated points for rewards through the platform’s network of participating businesses. Rewards may include discounts, products, or exclusive perks offered by the city or local merchants. The redemption process may be streamlined and accessible via the resident dashboard.

The platform may be built on a secure infrastructure designed to protect sensitive data and ensure safe multi-stakeholder access. Government-grade security measures may be implemented to safeguard user information and prevent unauthorized access. The scalable framework may allow the platform to accommodate growing user bases and expanding datasets.

Customization options may be available for cities and businesses to tailor the system to their specific needs. Cities may integrate internal datasets, such as attendance records or utility usage, to correlate with resident engagement activity. Third-party integrations may be supported, enabling cities and businesses to centralize insights and streamline operations.

Real-time communication tools may facilitate interaction between cities, businesses, and residents. Residents may receive alerts about emergency updates, community events, and neighborhood news through the app interface. Businesses may push promotions and updates directly to users, enhancing engagement and visibility.

The platform may track resident activity trends associated with point-earning behaviors, such as purchases and event attendance. This data may be analyzed to provide feedback to cities and businesses, enabling them to adjust strategies and improve outreach. The feedback loop may enhance economic activity and civic engagement by aligning incentives with real-world behavior.

The platform may unify civic and commercial incentives under one digital infrastructure. Residents may be rewarded for both civic participation and local spending, creating a holistic engagement model. This integration may benefit municipalities, small businesses, and residents by driving local economic growth and fostering community involvement.

A seamless user experience may be provided through a mobile or web application. Residents may register their profiles, view nearby offers, and track points earned from purchases or event participation. Businesses and city administrators may interact with the system through their respective dashboards, enabling efficient management of campaigns and rewards.

The platform may enable cities and businesses to make informed decisions based on real-time data and analytics. Cities may use insights to plan resources, allocate budgets, and develop policies that align with resident behavior. Businesses may optimize their marketing strategies and promotions based on customer engagement data.

While primarily designed for municipalities, the platform may be adapted for other sectors such as education, healthcare, and tourism. For example, schools may use the system to reward students for academic achievements, or healthcare providers may incentivize wellness activities.

Points earned by residents may be aggregated and stored in their digital accounts within the platform. The system may ensure accurate tracking and secure storage of points, enabling seamless redemption and analysis.

The platform may support city-sponsored events by enabling residents to earn points for participation. For example, users may scan quick response codes at events to trigger point allocation, encouraging attendance and engagement.

Businesses may use first-party data collected by the platform to create targeted campaigns without relying on third-party services. The merchant dashboard may provide tools for launching promotions, tracking performance, and building audiences based on customer behavior.

The platform may include support from data analysts who assist cities in interpreting insights and aligning them with strategic goals. Analysts may help formulate data-driven strategies to improve civic engagement and economic activity.

Visualizations of economic trends and consumer behavior may be provided, enabling cities to streamline planning and budgeting. These insights may help municipalities understand the impact of their initiatives and adjust strategies accordingly.

Residents may discover local offers, earn loyalty points, and stay informed about city updates through the app interface. The platform may personalize recommendations based on user location and activity, enhancing the overall experience.

Artificial intelligence may be leveraged to analyze data and generate insights for smarter decision-making. Artificial intelligence-driven analytics may help cities and businesses identify patterns, predict trends, and optimize engagement strategies.

Community events may be integrated into the loyalty system, encouraging residents to participate in civic activities. Event participation may be tracked and rewarded, fostering a sense of community and increasing engagement.

Cities may import internal datasets into the platform to correlate with resident engagement activity. This feature may enable deeper performance tracking and enhance the platform’s analytics capabilities.

The platform may adhere to strict privacy standards to protect user data and ensure compliance with relevant regulations. Personal information may be safeguarded, and the system may be designed to prevent identity theft and unauthorized access.

Aspects of the subject matter described in this disclosure can be implemented to realize one or more of the following potential advantages. The described techniques may be implemented to support the creation of a unified ecosystem that encourages collaboration between municipalities, businesses, and residents. The platform may enhance local economic resilience by fostering loyalty to small businesses and promoting civic participation. It may streamline the process of incentivizing community engagement through a centralized system that aligns with municipal objectives. The system may provide a scalable framework that adapts to varying city sizes and demographic needs, ensuring broad applicability. By leveraging real-time data, the platform may enable stakeholders to make timely and informed decisions that align with evolving community priorities.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100-a and 100-b). Further, as part of this description, some of this disclosure’s drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components. It should be understood that the language used in this disclosure has been principally selected for readability and instructional purposes, and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

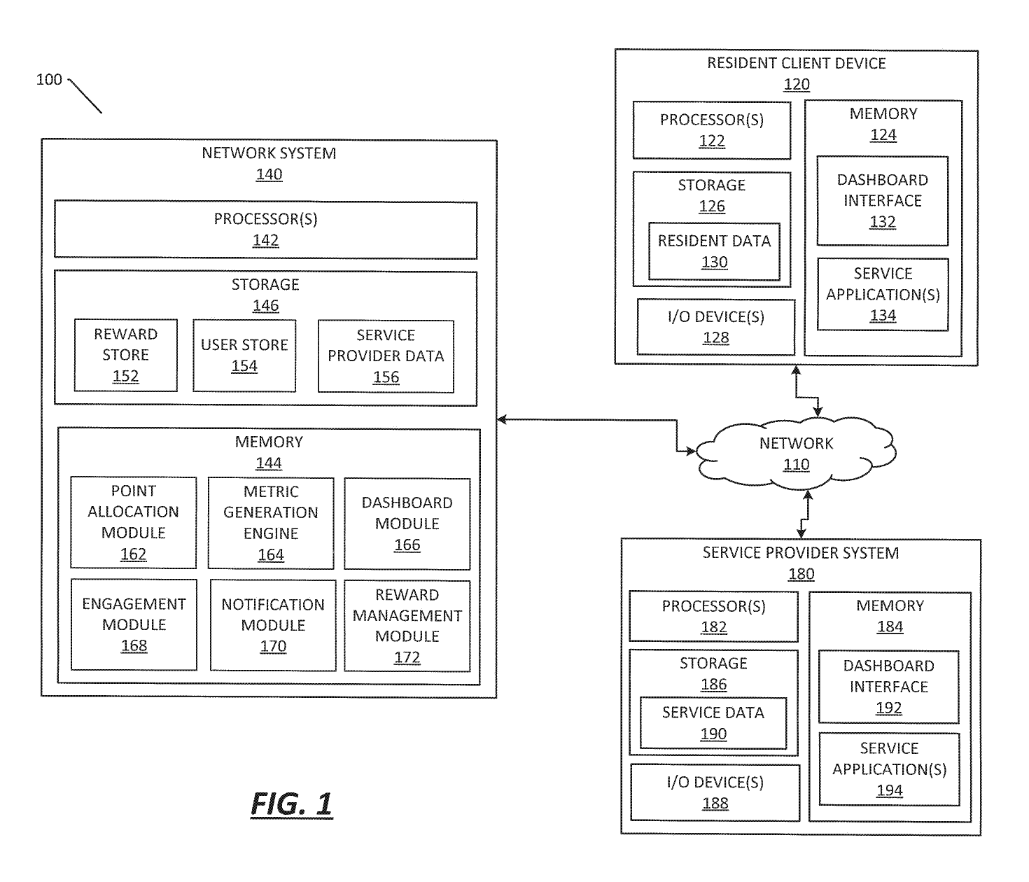

FIG. 1 illustrates an example of a network diagram 100 of various systems used for facilitating municipal engagement and local economic growth through a digital loyalty platform in accordance with aspects of the present disclosure. The individual functional elements shown in FIG. 1 are identified by particular terms, and described as performing particular functionality. However, it should be understood that the various components and functionality may be differently distributed across the network, or across additional devices.

In the example network diagram 100, network system 140 is communicatively coupled to a plurality of external computing entities, including a resident client device 120 and a service provider system 180 across a network 110. The various computational components shown in FIG. 1 may exchange data across any suitable wired, wireless, or hybrid communication fabric, thereby allowing seamless collection, processing, distribution, and display of community engagement data, reward information, and related analytics. Example networks include a wide-area network such as the Internet, which connects devices across vast geographic distances, allowing for global communication and data exchange. Additionally, local-area networks (LANs) enable devices within a limited area, such as a building or campus, to communicate and share resources efficiently. Moreover, metropolitan-area networks (MANs) span larger areas than LANs but are not as extensive as WANs, providing connectivity within cities or regions. These networks are typically utilized by businesses, educational institutions, and government entities to facilitate communication and access to centralized resources. Network 110 may be comprised of one or more different types of networks.

The network system 140 includes one or more computing devices, which include processor(s) 142 , memory 144 , and storage 146 that cooperate to execute various back-end platform functions. Storage 146 may maintain a reward store 152 that holds reward definitions, incentive catalogs, or voucher records that can be redeemed by qualifying users. User store 154 may store information regarding qualified and/or unqualified users, redemption records, user activity, or the like. Service provider data 156 may store merchant profiles, municipality configuration parameters, and other service-provider-specific content.

The network system 140 may include a memory 144 configured to host various programming modules executable by processor(s) 142. In the example shown, memory 144 includes a rewards management module 172 that orchestrates reward definition, fulfillment, and settlement. In some embodiments, the rewards management module 172 may identify public activity records related to purchases made at local businesses participating in the loyalty program, which may include restaurants, retail stores, or service providers. In some implementations, the rewards management module 172 may identify public activity records associated with attendance at city-sponsored events, such as festivals, workshops, or community clean-up drives. In some implementations, the rewards management module 172 may determine reward redemption data by matching point values from public activity records with seasonal rewards, such as discounts on holiday-themed items or limited-time offers. In some implementations, the rewards management module 172 may determine reward redemption data by accessing inventory levels to confirm the availability of specific reward items, such as physical goods or e-gift cards. In some implementations, the rewards management module 172 may determine reward redemption data by correlating point values with digital rewards, such as downloadable content or exclusive access to city-sponsored programs.

A point allocation engine 162 may apply rule sets, for example from rewards store 152 and/or service provider data 156, to community engagement data to determine point values. In some embodiments, the point allocation engine 162 may assign higher point values to public activity records associated with city-sponsored events that involve significant resident participation, such as town hall meetings or community clean-up drives. In some implementations, the point allocation engine 162 may apply a tiered structure to determine point values, where activities like attending educational workshops may receive mid-level points, while activities like participating in surveys may receive lower point values. In some implementations, the point allocation engine 162 may incorporate seasonal adjustments, where public activity records related to holiday events or festivals may receive unique point values based on the time of year.

A metric generation engine 164 may compute aggregated statistics such as redemption rates, demographic engagement trends, or economic impact scores. In some embodiments, the metric generation engine 164 may determine metrics such as the frequency of resident participation in city-sponsored events, such as town hall meetings or community clean-up drives. In some implementations, the metric generation engine 164 may determine metrics related to the diversity of activities residents engage in, such as attending educational workshops, participating in surveys, or visiting local businesses. In some implementations, the metric generation engine 164 may determine seasonal trends in public activity metrics, such as increased participation during holiday events or festivals.

The engagement management module 168 may coordinate campaigns across multiple stakeholders. In some embodiments, the engagement management module 168 may be configured to determine that one or more activity records for a particular community user may satisfy an engagement threshold, for example from user store 154 and/or service provider data 156. In some implementations, the engagement management module 168 may assess whether a community user’s attendance at multiple city-sponsored events within a specific timeframe may meet a predefined engagement threshold. In some implementations, the engagement management module 168 may determine if a community user’s participation in diverse activities, such as attending workshops and completing surveys, may collectively satisfy the engagement threshold. In some implementations, the engagement management module 168 may evaluate whether a community user’s frequency of interactions with local businesses, as recorded in public activity records, may meet the engagement threshold. In some embodiments, the engagement management module 168 may be configured to apply a categorization schema to the one or more public activity records to assign an activity type among a plurality of predefined activity types to each of the public activity records, wherein the activity type for each of the public activity records may be applied to the point allocation engine to obtain the point values associated with each of the plurality of public activity records.

The dashboard module 166 may generate and populate various dashboards for different stakeholders. In some embodiments, the dashboard module 166 may generate and/or provide real-time updates of community engagement activities, allowing users to view current participation levels. In some implementations, the dashboard module 166 may provide visual representations such as graphs or charts that may depict trends in public activity over time. In some embodiments, the dashboard module 166 may allow users to filter data by specific events or time periods, which may help in analyzing particular aspects of community engagement.

The notification module 170 may format and dispatch alerts, reminders, or promotional messages to downstream devices. In some embodiments, the notification module 170 may generate notifications that may include personalized messages encouraging the community user to participate in upcoming city-sponsored events. In some embodiments, the notification module 170 may generate notifications that may highlight specific rewards available to the community user based on their accumulated points. The notification module 170 may generate notifications that may suggest nearby local businesses participating in the loyalty program based on the community user’s location data, for example based on location data captured or tracked by a resident client device associated with the community user. In some implementations, the notification module 170 may generate notifications that may include seasonal offers or promotions tied to public activity records associated with holiday events or festivals. In some implementations, the notification module 170 may generate notifications that may recommend additional activities, such as surveys or workshops, that may help the community user earn more points.

The resident client device 120 is shown as a computer device that enables a resident or other community user to interact with the platform. Examples of the resident client device may include, for example, a laptop, desktop, tablet device, mobile device, wearable device, smart device, or the like. The device includes processor(s) 122 , memory 124 , storage 126 , and I/O device(s) 128 . Storage 126 may persist resident data 130 such as earned point balances, redemption history, user preferences, and locally cached content for a user. Memory 124 includes computer readable modules which may be processed by processor(s) 122. A dashboard interface 132 presents a graphical, audio, or other interface that surfaces points, rewards, alerts, and civic information. Service application(s) 134 include executable code that, when run by processor(s) 122 performs functions related to community or commercial services such as government applications, merchant apps, or the like, from which activity data can be detected and recorded. The depicted architecture allows the resident to earn, view, and redeem points while receiving location-based or context-aware notifications.

The service provider system 180 represents infrastructure that may be operated, for example, by a service provider, merchant, or other commercial or community entity. The system includes processor(s) 182, memory 184, storage 186, I/O device(s) 188, and service data 190. Memory 184 includes computer readable modules which may be processed by processor(s) 182. A dashboard interface 192 presents a graphical, audio, or other interface that allows a service provider to define points, rewards, alerts, and the like. Service application(s) 194 may perform functions related to community or commercial services such as government applications, merchant apps, or the like, from which activity data can be detected and recorded.

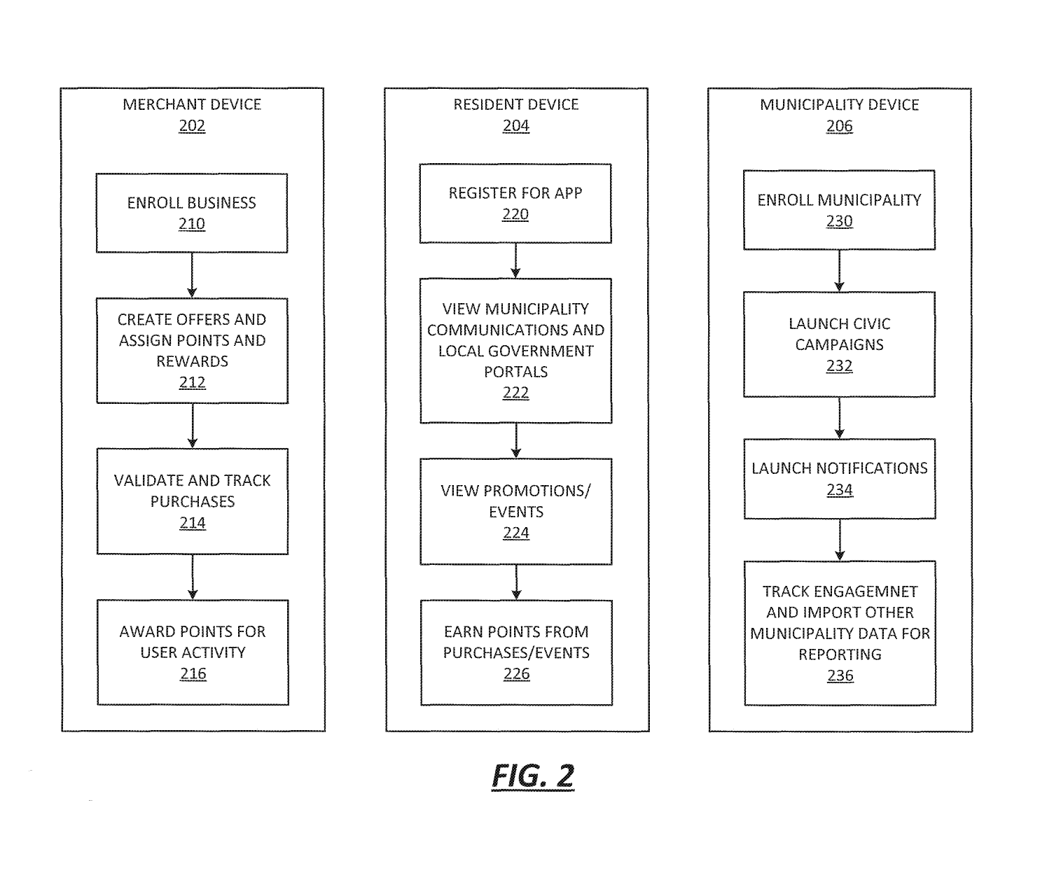

FIG. 2 illustrates a diagram of techniques for facilitating municipal engagement and local economic growth through a digital loyalty platform in accordance with various aspects of the present disclosure. Operations illustrated in the user interaction flowchart 200 may involve a resident, a merchant, and a municipality, and/or other participants, which may be examples of corresponding devices described herein. The user interaction flowchart 200 may describe processes for registering on the app, viewing communications and promotions, earning points, enrolling businesses and municipalities, creating offers, launching campaigns, and tracking engagement. Although the various steps are presented in a particular order, it should be understood that in some embodiments the various steps and processes may be performed in a different order. Further, some processes may be omitted, or others may be added. Moreover, in some embodiments, two or more of the processes may be performed simultaneously.

At 210, the merchant device 202 may enroll their business into the loyalty platform through a dedicated dashboard. In some implementations, merchant device 202 may provide business details such as their name, address, and type of services offered during the enrollment process. The merchant device 202 may upload a logo and other branding materials to customize the merchant’s presence on the platform. The dashboard may prompt the merchant device 202 to select a subscription plan or agree to terms of service before completing the enrollment. The merchant device 202 may receive a confirmation email or notification to verify their account and finalize the enrollment.

At 212, the merchant device 202 may create promotional offers and determine the points required for redemption. In some implementations, the merchant device 202 may use the dashboard to input details about the promotion, such as the discount amount or eligible products. The merchant device 202 may specify the duration of the promotion, including start and end dates. The dashboard may allow the merchant to set the number of points required for residents or other community members to redeem the offer. The merchant device 202 may preview the promotion before publishing it to ensure accuracy.

At 214, the merchant device 202 may validate and track purchases made by residents through the platform. In some implementations, the merchant device 202 may use the dashboard to review transaction details, such as the date, time, and amount spent by the resident. The merchant device 202 may scan a QR code or input a unique transaction ID to confirm the purchase. The platform may display a summary of validated purchases, allowing the merchant device 202 to monitor engagement trends. The merchant device 202 may flag or dispute transactions that do not meet the criteria for earning points.

At 216, the merchant device 202 may award points to a resident, such as a user of resident device 204, based on qualifying user activity. In some implementations, the merchant device 202 may automatically allocate points to the resident after a validated purchase. The merchant device 202 may manually adjust the number of points awarded in cases of special promotions or errors. The platform may notify the resident when points have been successfully added to their account. The merchant device 202 may provide a history of awarded points through the dashboard for record-keeping purposes.

Resident device 204 may provide a dashboard and/or other tools by which a resident can utilize the platform. At 220, the resident device 204 may register on the app to initiate participation in the loyalty platform. In some implementations, the resident device 204 may obtain personal details for a user, such as their name, email address, and location during the registration process. The resident device 204 may create a unique user profile that may be used to track their activity and engagement within the platform. The app may prompt the user to agree to terms and conditions before completing the registration. The resident device 204 may receive a confirmation email or notification to verify the user’s account and finalize the registration.

At 222, the resident device 204 may provide a view of municipality communications and may provide access to local government portals through the app. In some implementations, the resident device 204 may navigate to a dedicated section of the app that displays announcements from the municipality device 206. The resident device 204 may access information such as city council meeting schedules, public service updates, and community event details. The app may allow the resident to interact with certain features, such as submitting feedback or inquiries to the municipality. The resident device 204 may provide additional resources, such as links to external government websites or downloadable forms.

At 224, the resident device 204 may provide a view of promotions and events within the app interface. In some implementations, the app may present a curated list of promotions from participating merchants based on the location data for the resident device 204 or other preferences. The resident device 204 may provide an interface that allows a resident to browse event details, such as dates, times, and venues, directly within the app. The app may include filters that allow the resident to sort promotions by category, such as dining, retail, or entertainment. The resident device 204 may save specific promotions or events to their profile for easy access later.

At 226, the resident device 204 may track a resident’s points from purchases made at participating businesses or from attending events. In some implementations, the resident device 204 may scan a QR code provided by the merchant to record a purchase and request points. The resident device 204 may link a payment method to the app, allowing points to be automatically awarded for qualifying transactions. The app may track attendance at city-sponsored events by requiring the resident to check in through the app interface. The resident device 204 may present accumulated points in real time through a user profile.

Municipality device 206 may be an electronic device or system controlled by a municipality or other civic entity. At 230, the municipality device 206 may enroll in the loyalty platform to engage with residents and businesses. In some implementations, the municipality device 206 may obtain details such as the city name, contact information, and administrative permissions during the enrollment process. The municipality device 206 may upload official branding materials, such as logos and banners, to customize a municipality’s presence on the platform. The platform may prompt the municipality device 206 to agree to terms of service before completing the enrollment. The municipality device 206 may receive a confirmation email or notification to verify the municipality account and finalize the enrollment.

At 232, the municipality device 206 may launch civic campaigns to encourage participation and engagement. In some implementations, the municipality device 206 may use the platform to design campaigns that reward residents for specific actions, such as attending public meetings or participating in recycling programs. The municipality device 206 may obtain and provide campaign details, including objectives, timelines, and point allocations, through the dashboard. The platform may allow the municipality to target campaigns to specific neighborhoods or demographic groups. The municipality device 206 may provide a preview the campaign before launching it to ensure accuracy.

At 234, the municipality device 206 may launch notifications to communicate updates and events to residents. In some implementations, the municipality device 206 may use the platform to draft notifications about upcoming events, such as festivals or public hearings. The municipality device 206 may be used to schedule notifications to be sent at specific times or triggered by certain conditions, such as weather alerts. The platform may allow the municipality device 206 to provide multimedia content, such as images or videos, in the notifications. The municipality device 206 may review a history of sent notifications through the dashboard for record-keeping purposes.

At 236, the municipality device 206 may track engagement metrics and import additional data for reporting purposes. In some implementations, the municipality device 206 may provide the dashboard to view metrics such as the number of residents participating in campaigns or the total points earned. The municipality device 206 may import datasets, such as attendance records or utility usage, to correlate with platform activity. The platform may generate visual reports, such as charts or graphs, to help the municipality interpret the data. The municipality device 206 may export engagement metrics for use in external presentations or planning documents.

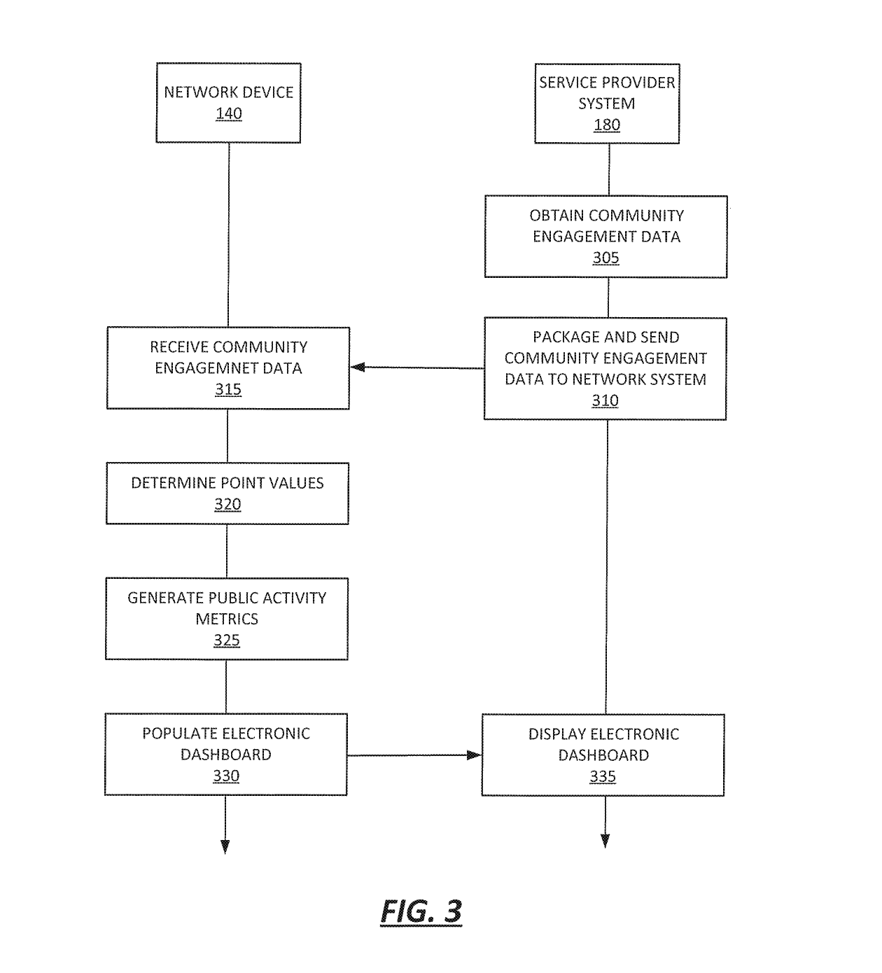

FIG. 3 illustrates a points allocation flowchart 300 that supports techniques for facilitating municipal engagement and local economic growth through a digital loyalty platform in accordance with various aspects of the present disclosure. In particular, FIG. 3 depicts an example diagram of a technique for a service provider system 180 providing community engagement data to a network system 140, in accordance with one or more embodiments.

The diagram begins at block 305, where the service provider system 180 obtains community engagement data from a plurality of distributed endpoints, such as community user devices, commercial devices such as point-of-sale terminals, or public service devices. Each record of community engagement data may be classified, for example, as an in-store purchase, attendance at a city-hosted event, or completion of a public-service action. Metadata such as timestamps, geo-coordinates, user identifiers, and device identifiers accompany the primary payload to facilitate later contextualization.

Upon generation of a batch, bundle, or “community package” by any upstream client or service, the flow diagram proceeds to block 310. In some embodiments, a lightweight edge-processing routine operating on the originating device signs, encrypts, and groups multiple public-activity records into the community package. The package is then transmitted to the network system. The data may be pushed to the network system via secure RESTful APIs, ingested via webhooks, polled by the system using scheduled fetch operations, or the like. In some embodiments, handshaking responses and acknowledgement codes are returned so that the service provider system 180 can mark the package as delivered and avoid duplication.

The flowchart proceeds to block 315, where the network system 140 receives the community engagement data. According to some embodiments, the data is validated, decompressed, and queued in network storage for downstream analytics. At block 320, the network device applies a configurable rule set against each public-activity record extracted from the incoming package. The rule set may incorporate various characteristics such as activity type weighting factors aligned with the categorization schema (e.g., purchases, event attendance, public-service participation); temporal multipliers (e.g., double points during municipal-designated “economic recovery weeks”); geofencing bonuses to incentivize commerce in specific business districts; and user-specific or demographic-specific modifiers. The engine outputs a numerical “point value” that is appended to the record and persisted storage.

The flowchart proceeds to block 325, where public activity metrics are generated. According to one or more embodiments, public activity metrics may include, for example, total points earned per user cohort, engagement density heat-maps by geographic grid, merchant-level redemption rates, campaign-level conversion funnels, and time-series forecasts produced by an embedded predictive model (e.g., LSTM or ARIMA). In some embodiments, resultant metrics are stored in a time-series database co-resident with storage, tagged with identifiers that allow selective retrieval according to the filtering operations. For example, public activity records may be filtered based on geographic location data, demographics, or the like. Further, in some embodiments, public activity metrics may include engagement trends segmented by demographic attributes derived from the community engagement data.

At block 330, the dashboards are populated with the generated metrics. In some embodiments, the merchant dashboards may be updated to reflect user engagement data. In some embodiments, municipality dashboards may also be updated to reflect engagement data. Then, at block 335, the dashboards may be viewed including the updated metrics. For example, a dashboard may display a heatmap of geographic locations associated with the public activity records to visualize community engagement density.

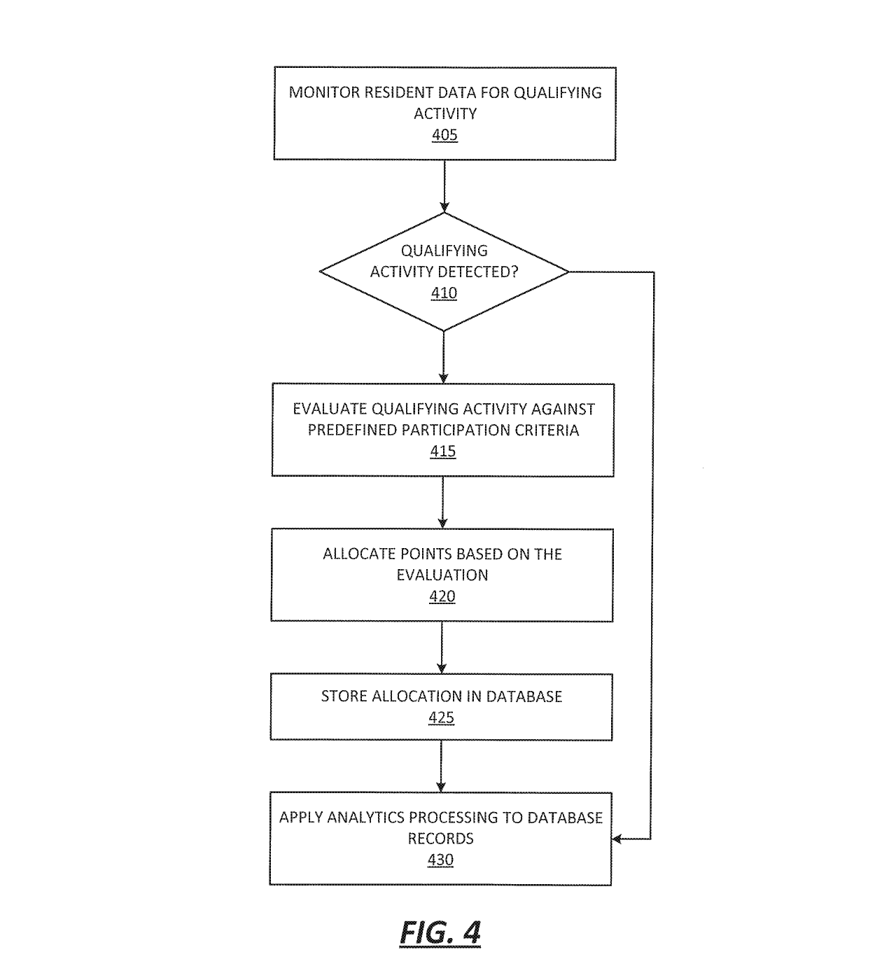

FIG. 4 illustrates a points allocation flowchart 400 that supports techniques for facilitating reward redemption via resident dashboard, in accordance with one or more embodiments. Although the various steps are presented in a particular order, it should be understood that in some embodiments the various steps and processes may be performed in a different order. Further, some processes may be omitted, or others may be added. Moreover, in some embodiments, two or more of the processes may be performed simultaneously.

At block 405, the system monitors resident data for qualifying activity. In some embodiments, the network system 140 may monitor resident data received from a resident device, a merchant or service provider device, or the like. In some embodiments, monitoring the resident data for qualifying user activity may be determined based on predefined rulesets which are compared against the resident data received from user engagements.

At decision block 410, if a determination is made that a qualifying event is detected, then the flowchart proceeds to block 415. At block 415, the detected activity is cross-referenced with rule sets that may incorporate campaign-specific participation criteria (for example, weighting factors defined by municipal administrators through a Municipality Dashboard). The rules may distinguish among predefined activity types, such as purchases, event attendance, or public-service participation.

At block 420, the Point Allocation Engine 162 assigns a numerical point value to the activity. An activity record can be created based on the received activity and the allocated points. The engine can apply variable coefficients reflecting frequency, geolocation, demographic segment, or campaign priority, thereby supporting the weighting factors.

At block 425, the finalized allocation event, inclusive of the activity metadata and computed point value, is committed to a structured database instance inside Storage 146. The resulting point record can be appended to a ledger maintained within Storage, and can be propagated to other components in the system, rendering the points redeemable across the centralized loyalty ecosystem.

At block 430, analytics routines can be executed over the records, which may include the new activity record arising from the eligible activity. In embodiments, in which a determination was made at block decision 410 that the activity was not a qualifying activity, the analytics routines may be performed without incorporating the new activity record. These routines may calculate engagement thresholds, geographic heatmaps, or predictive trend lines, thereby generating public activity metrics and enabling predictive analytics. The analytics output is cached for real-time retrieval by stakeholder dashboards, including the resident dashboard, the municipality dashboard, and the service provider dashboard. In some embodiments, the analytics routines can be used to generate additional public activity metrics based on the additional user activity records and the associated point values, and generating trend data based on the public activity metrics and the additional public activity metrics. Another example of analytics includes generating a ranking of users based on cumulative point values. In some embodiments, a predictive analytics module may forecast future engagement trends based on historical public activity records and associated point values. For example, the analytics data may be applied to a model that is trained to predict future analytics based on detected trends.

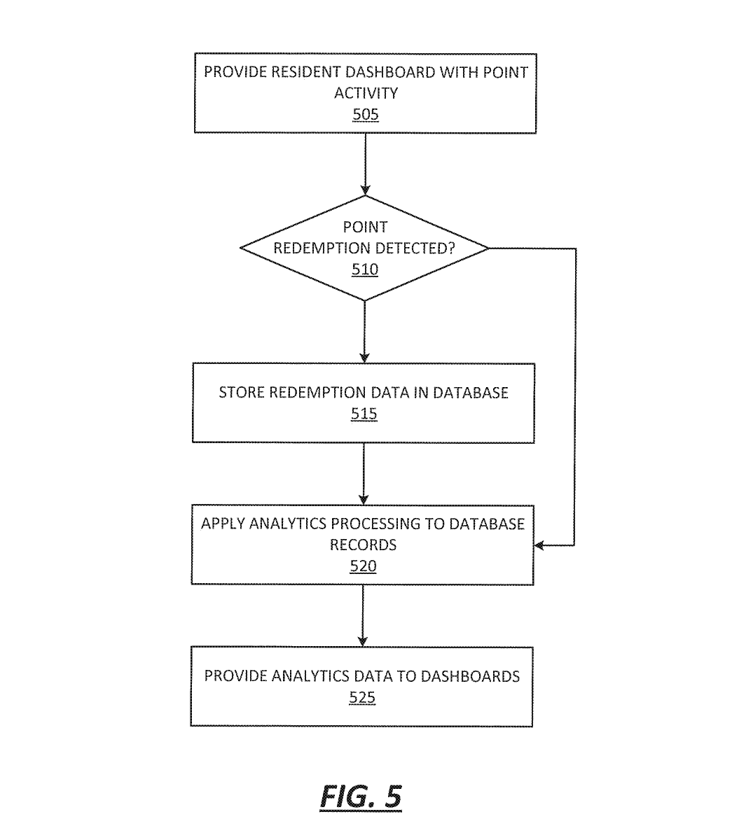

FIG. 5 depicts an example redemption-side workflow in accordance with one or more embodiments. Although the various steps are presented in a particular order, it should be understood that in some embodiments the various steps and processes may be performed in a different order. Further, some processes may be omitted, or others may be added. Moreover, in some embodiments, two or more of the processes may be performed simultaneously.

The flowchart begins at block 505, where a dashboard interface renders a resident-facing display of cumulative point totals, recent transactions, reward eligibility, and the like. At block 510, a determination is made as to whether the resident has initiated a redemption event. Such detection may arise, for example, from a QR code scan at a merchant device, a voucher click within the mobile Service Application, an in-person verification, from within the dashboard, or the like. The point redemption may be detected based on redemption activity generated at the resident device, or received by the resident device, for example from the merchant or service provider device, or elsewhere in the platform. If no redemption event is captured, control loops back to block 505 to maintain dashboard availability.

Upon affirmative detection, the flowchart proceeds to block 515, where redemption data is stored in a database. In some embodiments, storing the redemption data may include updating the resident’s point balance and archiving the specific reward identifier. In some embodiments, the merchant or provider which provided the reward may also log redemption metadata, such as time, location, merchant ID, and campaign code. The combined data may be used by the platform for aggregation and further analytics.

The flowchart proceeds to block 520, where analytics processing is applied to the database records. According to one or more embodiments, the system may compute redemption rates, offer performance metrics, or anomaly detections (e.g., error conditions such as the “Error encounter in scanning QR code” shown in the transaction landing page of the resident interface).

The flowchart concludes at block 525, where the processed analytics results are pushed to stakeholder dashboards via secure APIs. For residents, refreshed insights appear in the resident dashboard interface (e.g., voucher status, progress bars, or personalized suggestions). For municipal administrators, metrics populate the Municipality Dashboard, enabling oversight of civic campaign effectiveness and disparity analyses. Merchants may receive granular redemption analytics within the Merchant Dashboard, facilitating dynamic offer adjustments and marketing recommendations as contemplated in the marketing portal use case. In some embodiments, these analytics feed directly into merchant marketing recommendations and citywide economic reports, aligning with AI-driven autogenerated reports.

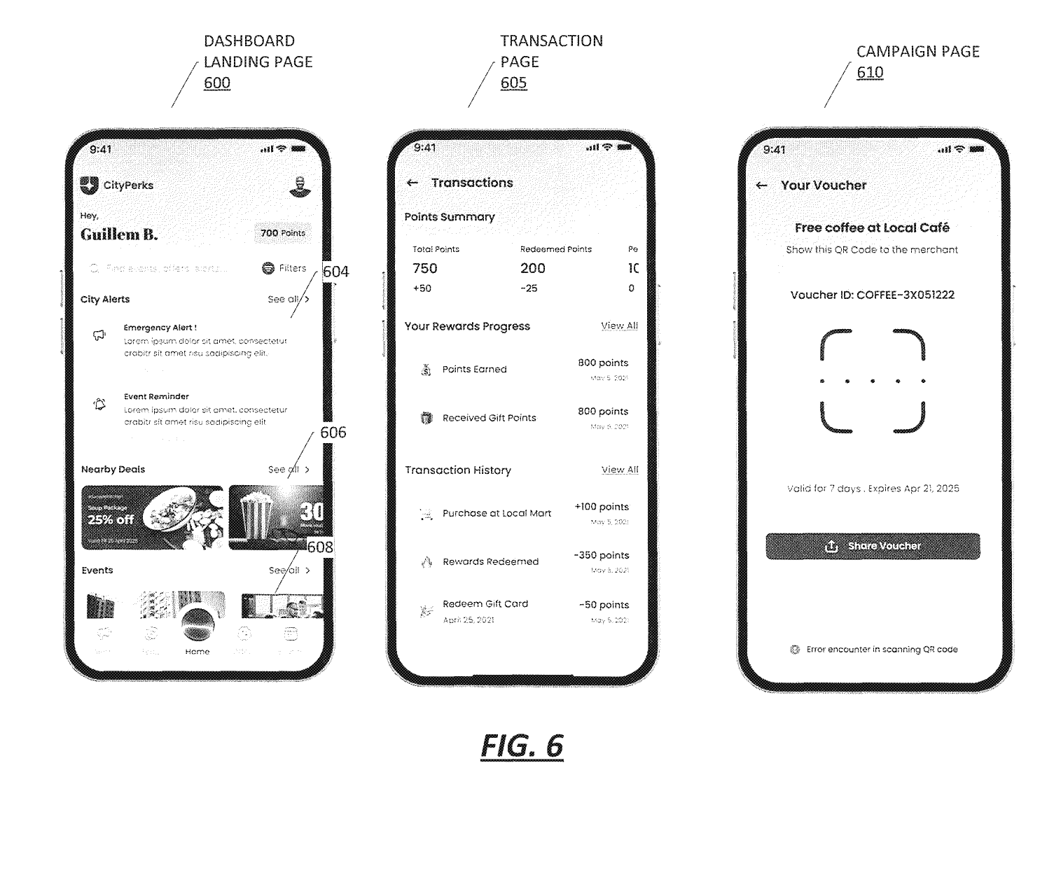

FIG. 6 shows an example resident dashboard landing page 600. The resident dashboard landing page 600 may include one or more of a city alerts section, a nearby deals section, an events section, and the like. The dashboard landing page 600 may include features for user interaction with the digital loyalty platform.

The dashboard landing page 600 may include features for user interaction with the digital loyalty platform. The dashboard landing page 600 may include a user-friendly design that allows residents to navigate through various sections such as city alerts, nearby deals, and events. The dashboard landing page 600 may provide a city alerts section 604, nearby deals section 606, and events section 608 to display relevant information to user. In some implementations, the dashboard landing page 600 may include additional features such as a search bar for locating specific offers or events.

The city alerts section 604 may provide notifications related to municipal updates and announcements. The city alerts section may include real-time notifications about emergency alerts, community events, and neighborhood updates. For example, a municipality server may interface with the platform to provide notifications which are propagated, via the dashboard, to residents. The city alerts section may display information in a categorized format, such as safety alerts, event reminders, or public service announcements. The city alerts section may interact with the admin dashboard interface to receive updates and announcements from city administrators. In some implementations, the city alerts section may allow users to customize the types of alerts they wish to receive.

The nearby deals section 606 may display localized promotions and discounts available to users. The nearby deals section 606 may include a list of participating businesses offering discounts or promotions within a specific geographic area. The nearby deals section 606 may determine the user’s location through GPS or user-inputted data to display relevant deals. The nearby deals section 606 may be populated from merchant data aggregated by the platform and propagated to resident devices via the dashboard. In some implementations, the nearby deals section 606 may include filters for users to sort deals by category, such as dining, retail, or services.

The events section 608 may represent scheduled activities and gatherings within the community. The events section 608 may include a calendar view or list format to display upcoming city-sponsored events, such as town halls, clean-up days, or cultural festivals. The events section 608 may allow users to RSVP or mark events of interest for reminders. The events section 608 may be populated with event details and updates from city administrators. In some implementations, the events section 608 may include a feature for users to share event information with others through social media or messaging platforms.

The dashboard landing page 600 may provide functionality to navigate to a transaction page 605. The transaction page 605 may present a visual display of accumulated points earned by the user through various activities. The transaction page 605 may include a graphical or numerical representation of the total points available in the user’s account. The transaction page 605 may allow users to view a breakdown of points earned from specific activities, such as purchases at local businesses or participation in city-sponsored events. The transaction page 605 may be integrated with the dashboard to ensure seamless access to point-related information. In some implementations, the transaction page 605 may include alternative visual formats, such as bar graphs or pie charts, to represent point distribution.

The dashboard landing page 600 may provide functionality to navigate to a campaign page 610. The campaign page 610 may include a section for showcasing redeemable rewards and offers available to the user. The campaign page 610 may present a categorized list of rewards, such as discounts, free products, or exclusive experiences, that users can exchange for their accumulated points. The campaign page 610 may allow users to filter or search for specific types of rewards based on their preferences or point balance. The campaign page 610 may be linked to the transaction page 605 to ensure users can determine the eligibility of rewards based on their current points. In some implementations, the campaign page 610 may include a feature for users to save or bookmark rewards for future redemption.

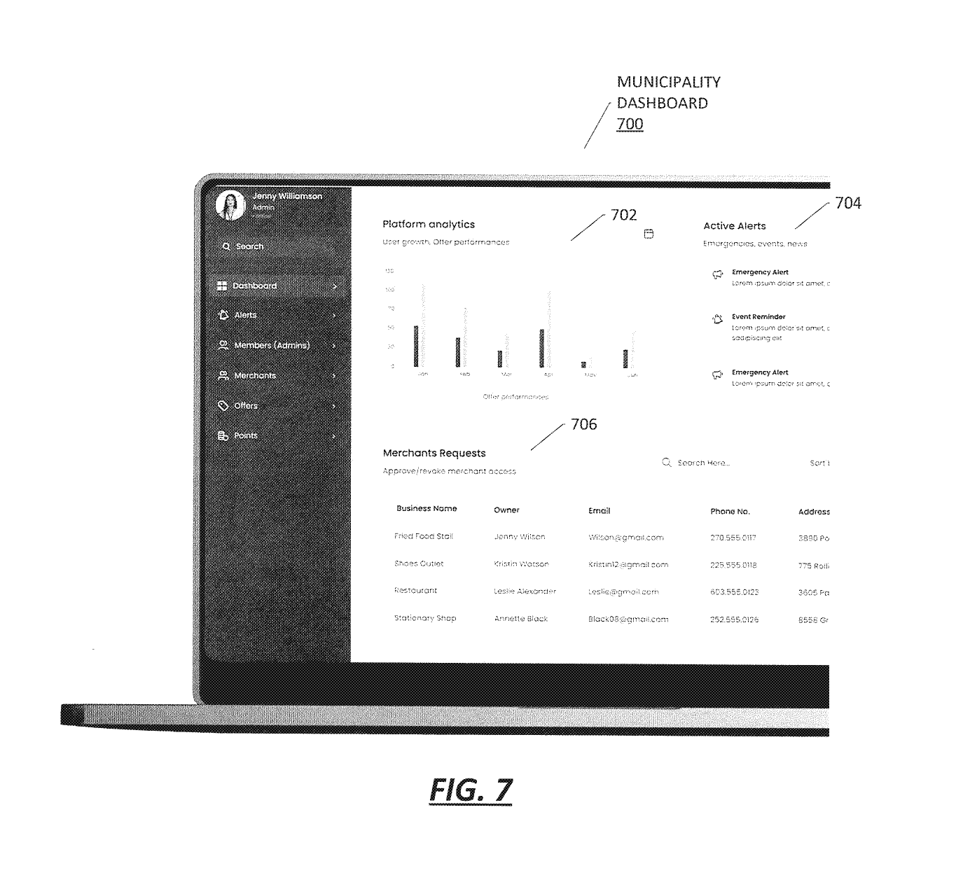

FIG. 7 shows a municipality dashboard 700 which supports techniques for facilitating municipal engagement and local economic growth through a digital loyalty platform in accordance with various aspects of the present disclosure. As depicted in FIG. 7, the municipality dashboard 700 may include one or more of a platform analytics 702, active alerts 704, merchants requests 706, and/or other components.

The platform analytics 702 may include tools for determining trends and patterns related to municipal engagement and local economic activity. In some implementations, platform analytics 702 may operate by aggregating real-time data from resident activities and merchant interactions to determine engagement patterns. The active alerts 704 may provide notifications related to city events, emergencies, or other time-sensitive updates. These alerts may be integrated into the resident dashboard, allowing users to receive real-time information directly on their devices. The active alerts 704 may be configured to prioritize notifications based on urgency, ensuring that residents are informed promptly about critical updates. Active alerts 704 may function by integrating city-level notifications and updates into the dashboard, which may be dynamically refreshed based on incoming data streams. The merchants requests 706 may represent submissions from local businesses seeking approval or assistance within the loyalty platform. Merchants requests 706 may interact with the administrative system to determine the status of pending approvals and display relevant merchant details, such as contact information and business addresses.

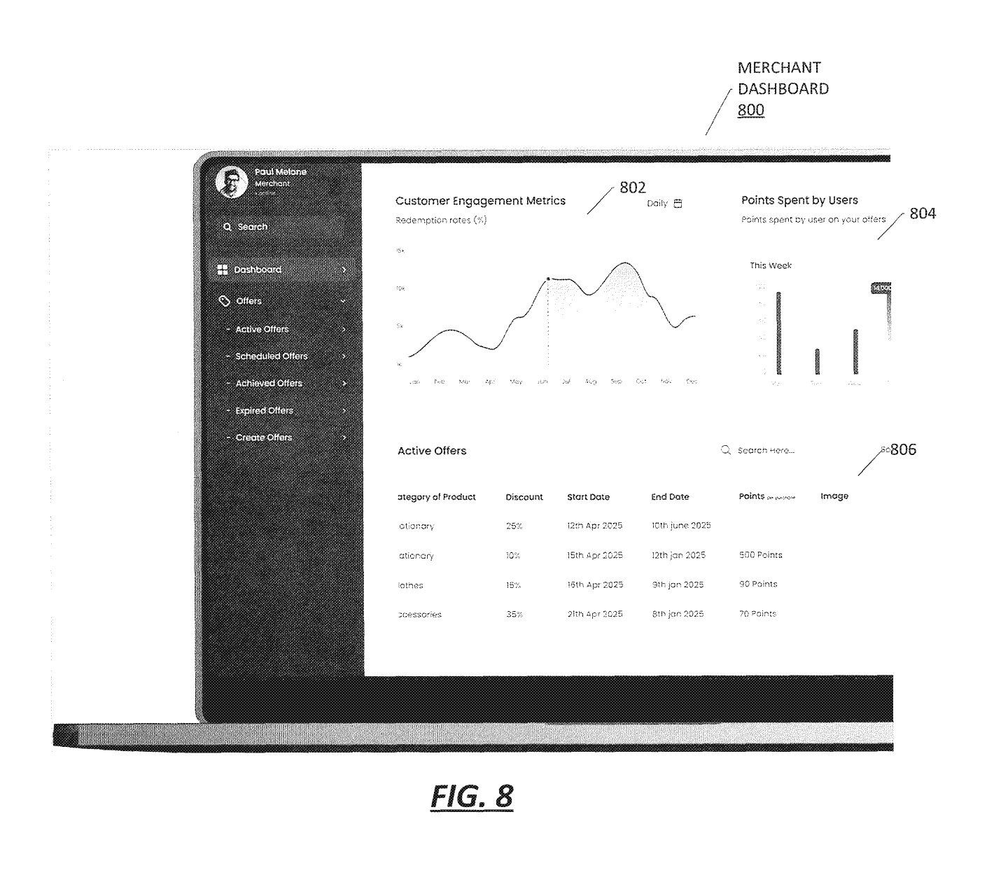

FIG. 8 shows a merchant dashboard 800 which supports techniques for facilitating municipal engagement and local economic growth through a digital loyalty platform in accordance with various aspects of the present disclosure. As depicted in FIG. 8, the merchant dashboard 800 may include one or more of a customer engagement metrics graph 802, points spent by users graph 804, an active offers table 806, and/or other components.

The customer engagement metrics graph 802 may include visual representations of user interactions with merchant campaigns over a specified time period. The customer engagement metrics graph 802 may display data points that represent the frequency and type of user interactions, such as clicks, views, or redemptions associated with specific merchant campaigns. The customer engagement metrics graph 802 may allow merchants to determine trends in user behavior, such as peak engagement times or popular campaign types. In some implementations, the customer engagement metrics graph 802 may enable merchants to view engagement data alongside campaign management tools. For example, the customer engagement metrics graph 802 may include filters that allow merchants to focus on specific time periods or campaign categories.

The points spent by users graph 804 may represent the distribution of loyalty points redeemed by users across various participating businesses. The points spent by users graph 804 may include data visualizations that show the total number of points redeemed, categorized by business type or location. The points spent by users graph 804 may allow merchants to determine which rewards or promotions are most frequently redeemed by users. In some implementations, the points spent by users graph 804 may be linked to the points summary tracker to enable users to view their individual redemption history. For example, the points spent by users graph 804 may include a breakdown of points redeemed for dining, retail, or service-based rewards.

The active offers table 806 may include a detailed list of ongoing promotions and campaigns initiated by merchants, along with their respective statuses. The active offers table 806 may list current promotions, including details such as category, discount, start and end dates, and points earned, which may assist merchants in managing and adjusting their promotional strategies. These components may work together to offer a comprehensive view of customer behavior and engagement, which may support businesses in making data-driven decisions.

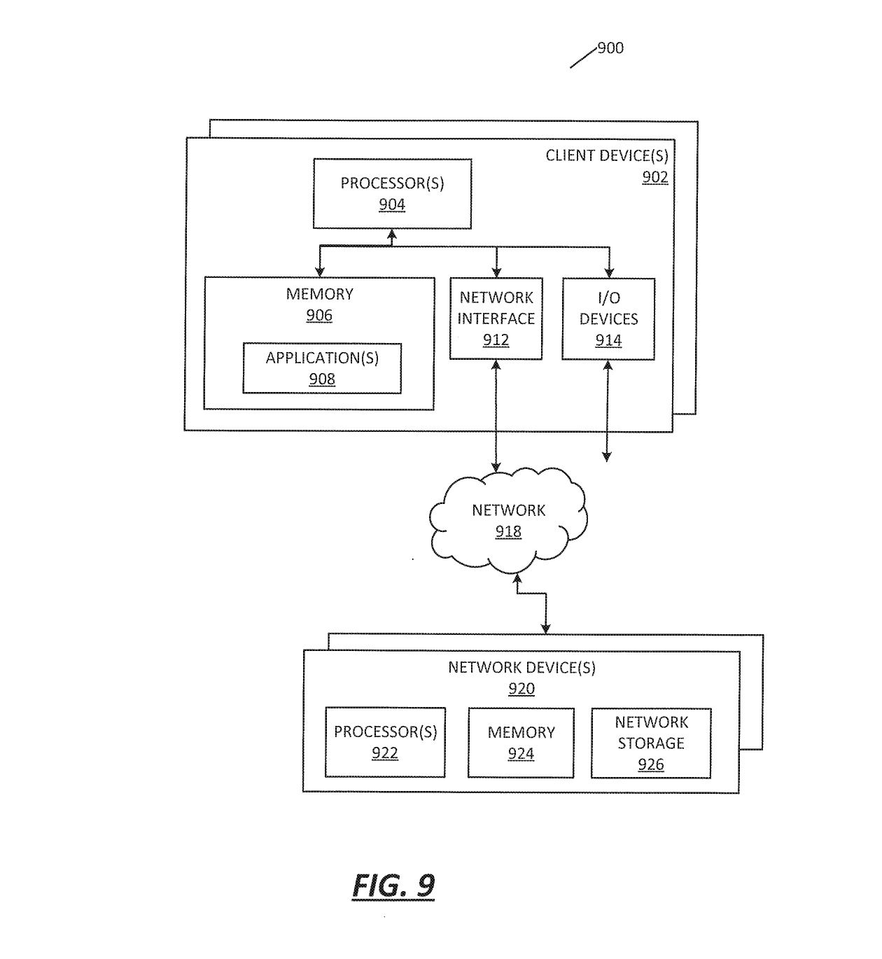

FIG. 9 shows an example of a hardware system for implementation of the various computer systems in accordance with the disclosed embodiments. FIG. 9 depicts a network diagram 900 including a client device 902 connected to one or more network devices 920 over a network 918. Client device 902 may comprise a personal computer, a tablet device, a smart phone, network device, or any other electronic device such as resident client device 120, service provider system 180, or the like. The network 918 may comprise one or more wired or wireless networks, wide area networks, local area networks, enterprise networks, short range networks, and the like. The client device 902 can communicate with the one or more network devices 920 using various communication-based technologies, such as Wi-Fi, Bluetooth, cable connections, satellite, and the like. Users of the client devices 902 can interact with the network devices 920 to access services controlled and/or provided by the network devices 920.

Client devices 902 may include one or more processors 904. Processor 904 may include multiple processors of the same or different type, and may be configured to execute computer code or computer instructions, for example computer readable code stored within memory 906. For example, the one or more processors 904 may include one or more of a central processing unit (CPU), graphics processing unit (GPU), or other specialized processing hardware. In addition, each of the one or more processors may include one or more processing cores. Client devices 902 may also include a memory 906. Memory 906 may each include one or more different types of memory, which may be used for performing functions in conjunction with processor 904. In addition, memory 906 can include one or more of transitory and/or non-transitory computer readable media. For example, memory 906 may include cache, ROM, RAM, or any kind of computer readable storage device capable of storing computer readable code. Memory 906 may store various programming modules and applications 908 for execution by processor 904. Examples of memory 906 include magnetic disks, optical media such as CD-ROMs and digital video disks (DVDs), or semiconductor memory devices.

Client device 902 also includes a network interface 912 and input/output (I/O) devices 914. The network interface 912 may be configured to allow data to be exchanged between client devices 902 and/or other devices coupled across the network 918. The network interface 912 may support communication via wired or wireless data networks. I/O devices 914 may include one or more display devices, keyboards, keypads, touchpads, mice, scanning devices, voice or optical recognition devices, or any other devices suitable for entering or retrieving data by one or more client devices 902.

Network devices 920 may include similar components and functionality as those described in client devices 902. Network devices 920 may include, for example, one or more servers, network storage devices, additional client devices, and the like, such as with network system 140. Specifically, network device 920 may include a memory 924, network storage 926, and/or one or more processors 922. The one or more processors 922 can include, for example, one or more of a central processing unit (CPU), graphics processing unit (GPU), or other specialized processing hardware. In addition, each of the one or more processors 922 may include one or more processing cores. Each of memory 924 and network storage 926 may include one or more of transitory and/or non-transitory computer readable media, such as magnetic disks, optical media such as CD-ROMs and digital video disks (DVDs), or semiconductor memory devices. In some embodiments, the point allocation engine 162, metric generation engine 164, dashboard module 166, engagement management module 168, notification module 170, and rewards management module 172 may be implemented as software modules stored in memory 924 and executed by processors 922 to perform the various functions described herein. While the various components are presented in a particular configuration across the various systems, it should be understood that the various modules and components may be differently distributed across the network.

According to some embodiments, limited user information may be used to perform techniques described herein. For example, limited personal information may be collected as required to generate orders at the request of the user. It should be understood that the privacy of individuals who use the intelligent order system and the AI tools described herein is protected under relevant privacy policies. In some embodiments, user information may be collected upon agreement of the end user to participate in such efforts in accordance with the relevant privacy policies.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A method for facilitating municipal engagement and local economic growth through a digital loyalty platform, comprising:
receiving, by a server, community engagement data from one or more resident client devices, one or more commercial devices, and one or more public service devices, wherein the community engagement data comprises a plurality of public activity records;
applying the community engagement data to a point allocation engine to determine point values associated with each of the plurality of public activity records; and
generating public activity metrics based on the public activity records and the point values associated with each of the plurality of public activity records; and
populating an electronic dashboard using the plurality of public activity records and the public activity metrics,
wherein the electronic dashboard is accessible to one or more of the one or more resident client devices, one or more commercial devices, and one or more public services devices across a network.

2. The method of claim 1, further comprising:
determining that one or more public activity records for a particular community user of the plurality of public activity records satisfies an engagement threshold; and
in response to the determination that the one or more public activity records satisfies the engagement threshold:
generating one or more notifications based on the public activity records associated with a particular community user, and
transmitting the one or more notifications to a particular resident client device associated with the particular community user of the one or more resident client devices.

3. The method of claim 1, further comprising:
applying a categorization schema to the plurality of public activity records to assign an activity type among a plurality of predefined activity types to each of the public activity records,
wherein the activity type for each of the public activity records is applied to the point allocation engine to obtain the point values associated with each of the plurality of public activity records.

4. The method of claim 3, wherein the plurality of predefined activity types comprises at least one selected from a group consisting of purchases, event attendance, and public service participation.

5. The method of claim 1, further comprising:
obtaining rewards availability data from a rewards store;
identifying a plurality of public activity records associated with a first community user; and
generating reward redemption data for the first community user by correlating the point values of each of the one or more of the public activity records with the rewards availability data.

6. The method of claim 5, further comprising:
generating a rewards redemption notification based on the reward redemption data; and
transmitting the rewards redemption notification to a first resident client device associated with the first community user.

7. The method of claim 1, further comprising:
filtering the public activity records based on geographic location data associated with the one or more resident client devices; and
generating the public activity metrics using the filtered public activity records.

8. The method of claim 1, further comprising:
in response to receiving additional user activity records:
generating additional public activity metrics based on the additional user activity records and the point values associated with each of the plurality of public activity records;
generating trend data based on the public activity metrics and the additional public activity metrics; and
populating the electronic dashboard using the trend data.

9. The method of claim 1, wherein the public activity metrics include engagement trends segmented by demographic attributes derived from the community engagement data.

10. The method of claim 1, wherein the point allocation engine applies a weighting factor to the point values based on a frequency of the public activity records within a predefined time period.

11. The method of claim 1, wherein the electronic dashboard displays a heatmap of geographic locations associated with the public activity records to visualize community engagement density.

12. The method of claim 1, wherein the public activity metrics comprise a ranking of community users based on cumulative point values associated with their public activity records.

13. The method of claim 1, wherein the electronic dashboard includes a predictive analytics module that forecasts future engagement trends based on historical public activity records and associated point values.

14. A system configured for facilitating municipal engagement and local economic growth through a digital loyalty platform, comprising:
a processor;
memory coupled with the processor; and
instructions stored in the memory and executable by the processor to cause the system to:
receive community engagement data from one or more resident client devices, one or more commercial devices, and one or more public service devices, wherein the community engagement data comprises a plurality of public activity records;
apply the community engagement data to a point allocation engine to determine point values associated with each of the plurality of public activity records; and
generate public activity metrics based on the public activity records and the point values associated with each of the plurality of public activity records; and
populate an electronic dashboard using the plurality of public activity records and the public activity metrics,
wherein the electronic dashboard is accessible to one or more of the one or more resident client devices, one or more commercial devices, and one or more public service devices across a network.

15. The system of claim 14, wherein the instructions are further executable by the processor to cause the system to:
determine that one or more public activity records for a particular community user satisfies an engagement threshold; and
in response to the determination that the one or more public activity records satisfies the engagement threshold:
generate one or more notifications based on the public activity records associated with a particular community user, and
transmit the one or more notifications to a particular resident client device associated with the particular community user.

16. The system of claim 14, wherein the instructions are further executable by the processor to cause the system to:
apply a categorization schema to the plurality of public activity records to assign an activity type among a plurality of predefined activity types to each of the public activity records,
wherein the activity type for each of the public activity records is applied to the point allocation engine to obtain the point values associated with each of the plurality of public activity records.

17. The system of claim 14, wherein the instructions are further executable by the processor to cause the system to:
obtain rewards availability data from a rewards store;
identify a plurality of public activity records associated with a first community user; and
generate reward redemption data for the first community user by correlating the point values of each of the one or more of the public activity records with the rewards availability data.

18. The system of claim 14, wherein the instructions are further executable by the processor to cause the system to:
filter the public activity records based on geographic location data associated with the one or more resident client devices; and
generate the public activity metrics using the filtered public activity records.

19. The system of claim 14, wherein the instructions are further executable by the processor to cause the system to:
in response to receiving additional public activity activity records:
generate additional public activity metrics based on the additional public activity records and the point values associated with each of the plurality of public activity records; and
generate trend data based on the public activity metrics and the additional public activity metrics; and populate the electronic dashboard using the trend data.

20. A non-transitory computer-readable medium storing code for facilitating municipal engagement and local economic growth through a digital loyalty platform, the code comprising instructions executable by a processor to:
receive community engagement data from one or more resident client devices, one or more commercial devices, and one or more public service devices, wherein the community engagement data comprises a plurality of public activity records;
apply the community engagement data to a point allocation engine to determine point values associated with each of the plurality of public activity records;
generate public activity metrics based on the public activity records and the point values associated with each of the plurality of public activity records; and
populate an electronic dashboard using the plurality of public activity records and the public activity metrics, wherein the electronic dashboard is accessible to one or more of the one or more resident client devices, one or more commercial devices, and one or more public service devices across a network.
